(19) United States
(12) Patent Application Publication
(10) Pub. No.: US 2024/0105409 A1
(43) Pub. Date: Mar. 28, 2024

(54) SWITCHING DEVICE

(71) Applicant: TDK Electronics AG, München (DE)

(72) Inventors: Richard Schoechert, Berlin (DE); Shun Yu, Schönefeld (DE); Rainer Morczinek, Kleinmachnow (DE)

(21) Appl. No.: 18/529,913

(22) Filed: Dec. 5, 2023

Related U.S. Application Data
(63) Continuation-in-part of application No. PCT/EP2022/065211, filed on Jun. 3, 2022.

(30) Foreign Application Priority Data
Jun. 8, 2021 (DE) 102021114675.5
Feb. 28, 2022 (DE) 102022104711.3

(51) Int. Cl. H01H 50/54; H01H 50/36

(52) U.S. Cl. CPC H01H 50/546; H01H 50/36

(57) ABSTRACT

In an embodiment a switching device includes at least one fixed contact, a contact bridge and a upper yoke element in a switching chamber, wherein the upper yoke element is attached to the switching chamber, wherein the upper yoke element has a recess on a lower side facing the contact bridge, and wherein the contact bridge projects at least partially into the recess in an switched-on state of the switching device.

### CROSS-REFERENCE TO RELATED APPLICATIONS

This patent application is a continuation-in-part of PCT/EP2022/065211, filed Jun. 3, 2022, which claims the priority of German patent application 102022104711.3, filed dated Feb. 28, 2022 and German patent application 102021114675.5, filed Jun. 8, 2021, each of which is incorporated herein by reference in its entirety.

### TECHNICAL FIELD

A switching device is specified.

### BACKGROUND

The switching device is embodied, in particular, as an electromagnetically acting, remotely actuated switch that can be operated by electrically conductive current. The switching device can be activated via a control circuit and can switch a load circuit. In particular, the switching device can be designed as a relay or as a contactor, in particular as a power contactor. Particularly preferably, the switching device can be designed as a gas-filled power contactor.

One possible application of such switching devices, in particular power contactors, is the opening and disconnection of battery circuits, for example in motor vehicles such as electrically or partially electrically operated motor vehicles.

In its function as a safety component, a contactor is usually used in combination with a fuse between a battery, such as a lithium-ion battery, and an electric motor and must be able to disconnect the power source from the load in the event of malfunction. A serious case of battery malfunction is a short circuit within the battery, which, depending on the battery, can lead to a very rapid discharge when fully charged, with currents in the kilo-ampere range and thus a multiple of the nominal current. The main task of the contactor in such a case is to carry this very high current for a short time, for example in the range of milliseconds, until the upstream fuse can safely disconnect the current or the current reduces due to an increasing internal resistance of the battery.

A contactor usually has a switching bridge which can be moved by a magnetic drive and which, for example, connects two fixed main contacts in an electrically conductive manner when the contactor is switched on. When a high short-circuit current occurs, however, strong Lorentz forces are generated by the magnetization of the conductors, which push the switching bridge away from the main contacts. This phenomenon is also known as levitation. Levitation can cause an unwanted arc to occur between the main contacts and the bridge, which burns at a very high temperature. This can destroy the contactor.

A magnetic field proportional to the current strength is formed around a current-carrying conductor. In existing solutions, the magnetic field caused by the current flowing in the switching bridge is concentrated in iron parts, which attract each other as a result. The attraction force is also called reluctance force, which can be used to press the switching bridge more strongly against the main contacts and prevent the contactor from opening.

For example, the document CN209000835 U describes an anti-levitation device in which a switching bridge is preloaded with a compression spring and held between an insulator and a retaining cage. The switching bridge is divided in the middle into two current paths. Both paths are embraced by an iron plate and an iron clamp, respectively, with the iron plates locked to the retaining cage and the iron clamps attached to the switching bridge.

If an electric current now flows through the switching bridge, a respective magnetic flux is formed around each current path, which is bundled in the respective iron parts. An attractive force acts between the iron parts, which endeavors to close the air gap. With this force, the switching bridge is additionally pressed against the main contacts and thus prevented from opening, wherein the air gap does not change and is only predetermined by the design of the components. The maximum retaining force and thus the maximum short-circuit current are thus limited by the following parameters: Force of the compression spring, cross-section of the iron parts, retaining force of the solenoid drive, size of the air gap.

Publications EP 2 608 235 B1 and DE 10 2016 206 130 A1 also describe anti-levitation devices, but in which there is no division of the switching bridge into several current paths and thus only one pair of iron parts in each case.

### SUMMARY

Embodiments Provide a Switching Device.

According to at least one embodiment, a switching device has at least one fixed contact and at least one movable contact. The movable contact can in particular comprise or be a contact bridge. In other words, the contact bridge can be a movable contact of the switching device or part of a movable contact of the switching device. Properties and features of the movable contact described below can thus be corresponding properties and features of the contact bridge, and vice versa. The switching device can particularly preferably have a contact arrangement comprising the movable contact, i.e. the contact bridge.

The at least one fixed contact and the at least one movable contact are intended and configured to switch on and off a load circuit that can be connected to the switching device. The movable contact, i.e. in particular the contact bridge of the contact arrangement, is correspondingly movable in the switching device between a non-through-connecting state and a through-connecting state of the switching device in such a way that the movable contact, i.e. in particular the contact bridge of the contact arrangement, is spaced apart from the at least one fixed contact in the non-through-connecting state of the switching device and is thus electrically isolated and in the through-connecting state has a mechanical contact to the at least one fixed contact and is thus electrically connected to the at least one fixed contact. In the following, the switching-through state is also referred to as the switched-on state of the switching device, while the non-through-connecting state is referred to as the switched-off state of the switching device.

Particularly preferably, the switching device has at least two fixed contacts which are arranged separately from one another in the switching device and which can be electrically conductively connected to one another or electrically separated from one another in the manner described above depending on the state of the movable contact, i.e. in particular of the contact bridge. The contact bridge preferably has an upper side with at least one contact area and a lower side opposite the upper side. In the through-connecting state of the switching device, the at least one contact region of the contact bridge is in mechanical contact with the at least one fixed contact, in particular a contact region of the at least one fixed contact. If the switching device has two fixed contacts, for example, the contact bridge can have two contact areas accordingly.

Hereinafter, the general term “contacts” can refer in particular to all fixed contacts as well as to the contact bridge or the contact arrangement with the contact bridge. In particular, the contacts can comprise or be made of a metal, preferably copper or a copper alloy. Furthermore, at least for the contact areas, for example, a composite material in the form of a metallic matrix material, preferably with or made of copper, and particles distributed therein, preferably with or made of a ceramic material such as aluminum oxide, is also possible.

According to a further embodiment, the switching device has a housing in which the contact arrangement and the at least one fixed contact or the at least two fixed contacts are arranged. The contact arrangement can in particular be arranged completely in the housing. The fact that a fixed contact is arranged in the housing can in particular mean that at least the contact region of the fixed contact, which is in mechanical contact with the movable contact in the through-connecting state, is arranged inside the housing. For connecting a supply line of a circuit to be switched by the switching device, a fixed contact arranged in the housing can be electrically contactable from outside, i.e. from outside the housing. For this purpose, a fixed contact arranged in the housing can protrude with a part from the housing and have a connection possibility for a supply line outside the housing.

According to a further embodiment, the contacts are arranged in a gas atmosphere in the housing. In particular, this can mean that the contact arrangement is arranged entirely in the gas atmosphere in the housing and that further at least parts of the fixed contact or contacts, such as the contact area or areas of the fixed contact or contacts, are arranged in the gas atmosphere in the housing. Accordingly, the switching device can particularly preferably be a gas-filled switching device such as a gas-filled contactor.

According to a further embodiment, the contacts, i.e. the contact arrangement in its entirety as well as at least parts of the fixed contact(s), are arranged in a switching chamber within the housing. The switching chamber can contain a gas, i.e. at least part of the previously described gas atmosphere. The gas can preferably comprise at least 20% H₂ and preferably at least 50% H₂. In addition to hydrogen, the gas can comprise an inert gas, particularly preferably N₂ and/or one or more noble gases.

According to a further embodiment, the contact bridge in the switching device is movable by means of a shaft. Particularly preferably, the contact arrangement in the switching device is movable by means of the shaft. In particular, the contact bridge and especially preferably the contact arrangement can be movable by means of an armature comprising the shaft. The shaft can be directly or indirectly connected to the contact bridge at one end in such a way that the contact bridge can be moved by means of the shaft, i.e. is also moved by the shaft when the shaft is moved. Particularly preferably, the shaft can be connected at one end to the contact arrangement in such a way that the contact arrangement can be moved by means of the shaft, i.e. is also moved by the shaft when the shaft is moved. In particular, the shaft can project into the switching chamber through an opening in the switching chamber. The armature can be movable by a magnetic circuit to affect the switching operations described above. For this purpose, the magnetic circuit can comprise a yoke having an opening through which the shaft of the armature projects. The shaft can preferably comprise or be made of stainless steel. The yoke can preferably have or be pure iron or a low doped iron alloy.

According to a further embodiment, the contact arrangement has a retaining element. The retaining element can be fastened to the shaft in particular. Furthermore, the retaining element and thus the contact arrangement can be locked to the shaft. This can be possible, for example, by means of a snap ring or a riveting onto the shaft. Furthermore, the retaining element and thus the contact arrangement can be screwed onto the shaft. For this purpose, the retaining element can have, for example, a hole with a thread or with a molded threaded bushing with a thread, with which the retaining element can be screwed onto a thread of the shaft. Additionally, in this case, the retaining element can be locked to the shaft, for example also by means of a snap ring and/or a rivet and/or a lock nut. Furthermore, it can also be possible for the shaft to be secured in the retaining element by a clamp and/or for a portion of the shaft to be molded with the material of the retaining element. In this case, the shaft can preferably have one or more anchoring elements, such as one or more grooves and/or one or more protrusions, which can extend completely or partially around the shaft.

According to a further embodiment, the switching device has an upper yoke element. The upper yoke element is particularly preferably arranged separately from the contact bridge and particularly preferably separately from the contact arrangement in the switching device. In particular, the upper yoke element can be immovably arranged and fixed in the switching device.

According to a further embodiment, the switching device has a lower yoke element in addition to the upper yoke element. In particular, the contact arrangement comprises the lower yoke element. The lower yoke element is thus preferably part of the contact arrangement.

The upper yoke element or the upper yoke element and the lower yoke element can each comprise or be made of iron. In particular, the upper yoke element or the upper yoke element and the lower yoke element can each comprise or be made of pure iron.

Preferably, the upper yoke element, in contrast to the lower yoke element, is not part of the contact arrangement, but is arranged independently of the contact arrangement and thus, in the event that the contact arrangement comprises the lower yoke element, in particular independently of the lower yoke element in the switching chamber. Particularly preferably, the upper yoke element is arranged and locked in an invariable manner with respect to its position relative to the at least one fixed contact. The upper yoke element can be attached to the switching chamber. For example, the upper yoke element can be attached to an inner surface of the switching chamber, preferably by soldering or bonding. Alternatively, the upper yoke element can be attached to the switching chamber by a rivet or screw connection. Further, the upper yoke element can be held to the inside of the switching chamber, for example, by means of a fastening part, such as one made of a plastic material. For example, the upper yoke element can be fixed in the switching chamber by press-fit stem. In this case, the upper yoke element can be inserted loosely into the switching chamber or a part of the switching chamber, for example, and locked in the switching chamber during assembly, particularly preferably in a form-fitting manner, by clamping or press-fit stem. By the fact that the upper yoke element is not part of the contact arrangement, it can be achieved with advantage, in contrast to the prior art described above, that the upper yoke element is not moved during the switching movement of the contact arrangement. As a result, the upper yoke element can, for example, be designed with larger dimensions than conventional yoke elements in the prior art, since the mass of the upper yoke element is irrelevant with regard to the switching movement.

According to a further embodiment, the lower yoke element is shiftably mounted on the retaining element. Accordingly, the position of the lower yoke element relative to the upper yoke element can change on the one hand as a result of a movement of the lower yoke element in the contact arrangement. Thus, an air gap between the lower yoke element and the upper yoke element can be changeable, in particular, even in a switched-on state of the switching device. On the other hand, for the preferred case where the upper yoke element is attached to the switching chamber, the position of the lower yoke element can change relative to the upper yoke element due to a movement of the contact arrangement in the switching chamber. Particularly preferably, the lower yoke element is mounted on the retaining element so as to be shiftable in a direction parallel to the shaft.

According to a further embodiment, the contact bridge is arranged on the retaining element. In particular, the contact bridge can be shiftably mounted on the retaining element. Particularly preferably, the contact bridge can be mounted on the retaining element so as to be shiftable in a direction parallel to the shaft.

The fact that an element, i.e. in particular the lower yoke element and/or the contact bridge, is shiftably mounted on the retaining element can mean in particular that the element is movable in preferably only one direction, which can also be referred to as the direction of movement, with respect to the retaining element and at the same time is restricted in its freedom of movement by the retaining element. The restriction of the freedom of movement can be present along the direction of movement, so that the shiftability along the direction of movement is limited to a certain distance. Preferably, the freedom of movement in directions other than the direction of movement is at least significantly restricted, except for tolerances.

Particularly preferably, in the event that the lower yoke element is present, the contact bridge, the lower yoke element and the upper yoke element are each mounted movably relative to one another in pairs. This means that the contact bridge and the lower yoke element are mounted movably relative to one another, since the contact bridge and/or the lower yoke element are mounted movably on the retaining element. Furthermore, the contact bridge and, if present, the lower yoke element are movably mounted relative to the upper yoke element, which can be achieved, for example, by the contact bridge and, if present, the lower yoke element being parts of the movable contact arrangement, whereas the upper yoke element is not part of the contact arrangement.

For example, the retaining element can have at least one guide element for guiding the contact bridge and/or the lower yoke element. The at least one guide element can, for example, be formed by a guide rail and can, in particular, provide guidance and thus a direction of movement along the direction parallel to the shaft. Particularly preferably, the retaining element has a plurality of guide elements. By means of the guide elements, it is preferably also possible to achieve a limitation of the mobility in directions other than the intended direction of movement. Furthermore, the retaining element can have at least one stop for limiting the shiftability of the contact bridge and/or the lower yoke element. In particular, the at least one stop can provide a limitation along the direction of movement and thus preferably along the direction parallel to the shaft. Particularly preferably, the retaining element can have several stops.

For example, the retaining element can have at least one clamp element that has the at least one guide element and the at least one stop and that at least partially engages around the contact bridge and/or the lower yoke element. The at least one clamp element can be arranged, for example, on a base plate of the retaining element. In particular, the clamp element can comprise a stop that is connected to the base plate via two guide elements, such that the guide elements and the stop of the clamp element together with the base plate surround an opening. The contact bridge and/or the lower yoke element can project through the opening. Particularly preferably, the retaining element has at least two clamp elements.

According to a further embodiment, the contact bridge is arranged between the base plate of the retaining element and the upper yoke element. In case the lower yoke element is present, the contact bridge is arranged between the lower yoke element and the upper yoke element. In particular, the upper yoke element can be arranged above the contact arrangement as viewed from the shaft. The contact bridge can have an upper side and a lower side opposite the upper side, wherein the lower yoke element, if present, is arranged below the contact bridge and thus at the lower side of the contact bridge, while the upper yoke element is arranged above the contact bridge and thus at the upper side of the contact bridge.

According to a further embodiment, the upper yoke element has a recess on a lower side facing the contact bridge. The recess can be embodied in particular as a channel-like or groove-like recess. The contact bridge can partially protrude into the recess in a switched-on state of the switching device. In particular, the recess can have a width that, at least in the region of the recess, is greater than a width of the contact bridge. For example, the contact bridge can have a constriction, i.e., a region having a reduced width, the constriction being arranged at least partially within the recess of the upper yoke element in a switched-on state of the switching device. Further, the recess can have a depth that, at least in the region of the recess, is equal to or substantially equal to a thickness of the contact bridge. Further, the contact bridge can also have a thickness that is greater than the depth of the recess. The contact bridge can enter the recess during the transition from a switched-off state to a switched-on state of the switching device due to the switching motion of the contact arrangement. Thus, the upper yoke element can at least partially surround the contact bridge in a switched-on state. Preferably, the contact bridge can partially protrude from the recess in the switched-on state of the switching device.

Furthermore, the contact bridge can also be spaced from the upper yoke element in the switched-on state. In other words, the contact bridge can thus have no mechanical contact with the upper yoke element in the switched-on state. Accordingly, an air gap can remain between the upper yoke element and the contact bridge even in the switched-on state.

According to a further embodiment, the retaining element comprises an electrically insulating material. Particularly preferably, the retaining element is made of one or more electrically insulating materials so that the retaining element can be electrically insulating. The electrically insulating material or materials can be selected from polymers and ceramic materials, for example selected from polyoxymethylene (POM), in particular having the structure (CH₂O)ₙ, polybutylene terephthalate (PBT), glass fiber-filled PBT, and electrically insulating metal oxides such as AlO₂₃. In particular, the retaining element can electrically isolate the contact bridge, or preferably the contact bridge and contact spring, and the lower yoke element from the shaft. As a result, the contact bridge can be electrically insulated from the components of the solenoid drive, i.e., in particular from the other components of the armature. The retaining element can thus simultaneously provide a bearing for the contact bridge and electrical insulation of the contact bridge.

For example, the upper yoke element can be arranged laterally adjacent to the at least one fixed contact. Here and in the following, “lateral” refers to directions that are perpendicular to the shaft of the armature. Particularly preferably, the switching device has two fixed contacts and the upper yoke element is arranged between the two fixed contacts.

Furthermore, it can be possible for the retaining element to have a part, for instance such as a stop described above, which projects into a space between the at least one fixed contact and the upper yoke element in a switched-on state of the switching device. This can, for example, provide electrical isolation of the upper yoke element from the at least one fixed contact. In the case of two fixed contacts between which the upper yoke element is arranged, the retaining element can preferably accordingly comprise two parts such as two stops, wherein each of the stops can protrude into a space between one of the fixed contacts and the upper yoke element in an energized state of the switching device.

According to a further embodiment, the contact arrangement further comprises a spring, which can also be referred to in the following as a contact spring, which is arranged on a lower side of the contact bridge facing away from the upper yoke element. If the contact arrangement also comprises the lower yoke element, the contact spring is thus arranged on the lower side of the contact bridge facing the lower yoke element. The contact spring can particularly preferably press the contact bridge in the direction of the at least one fixed contact. During a switching operation of the switching device from a switched-off state to a switched-on state, the armature and thus the shaft as well as the contact arrangement preferably move in a linear motion in the form of a lifting or lowering motion along the shaft, which can also be referred to as the vertical direction. Preferably, the shaft and, for example, a magnetic core of the armature have a range of movement in the vertical direction for the stroke movement that is larger than the switching gap formed by the distance between the at least one fixed contact and the contact bridge in the non-through state. This can be made possible, for example, by a gap between the magnetic core and the yoke of the magnetic circuit, which can also be referred to as the movement gap, being larger than the switching gap in the switched-off state. When the contact bridge strikes the at least one fixed contact, and thus when the switching gap is completely closed, the contact spring can be compressed and the armature can move further until, for example, the magnetic core is in contact with the yoke. Thus, the armature with the contact arrangement can be an overtravel system in which the contact bridge is shiftably arranged on the retaining element. For example, the movement gap can be smaller than or equal to 1 mm and, particularly preferably, larger than the switching gap by about 0.5 mm. Due to a spring deflection of the contact spring caused by the overtravel, the contact pressure of the contact bridge on the at least one fixed contact can be increased and a certain insensitivity to vibrations and mechanical shocks can be achieved.

According to a further embodiment, the contact spring is arranged between the contact bridge and the base plate of the retaining element or, in the case of an existing lower yoke element, between the contact bridge and the lower yoke element, so that the contact spring strives to press the contact bridge and base plate or the contact bridge and the lower yoke element apart. The contact spring thus generates, in particular, a spring force that counteracts an approach of the lower yoke element to the base plate or to the contact bridge. The spring can bear, preferably directly, against the lower side of the contact bridge and against the base plate or the lower yoke element. In the second case, the lower yoke element can have a recess into which the spring projects and which can fix the position of the contact spring. In the case where the switching device does not have a lower yoke element, the retaining element, in particular the base plate, can have a spring retainer that counteracts displacement of the contact spring on the retaining element. For example, the spring retainer can have or be formed from a pin surrounded by a part of the contact spring.

When the switching device is switched on, a magnetic field is induced in the upper yoke element when a current flows through the contact bridge. In this process, especially in the case of a large current such as a short-circuit current through the contact bridge, the magnetic field lines can bundle on the upper side of the upper yoke element. Since the field aims for the shortest path to minimize energy, the field on the bottom side facing the contact bridge and through the contact bridge is strongly compressed and generates a reluctance force on the contact bridge which counteracts the levitation force and which can accordingly also be referred to as an anti-levitation force. Thus, a retaining effect can be achieved by a flux of the magnetic field from the upper yoke element through the contact bridge.

In the case where the switching device has the lower yoke element, the contact bridge is particularly preferably arranged between the upper yoke element and the lower yoke element as previously described. In addition to the previously described effect of the upper yoke element on the contact bridge, the yoke elements can also in this case absorb magnetic fields that arise when current flows through the contact bridge. This means that in this case, the two yoke elements are magnetized by a magnetic field created by the current flowing through the contact bridge such that an attractive force is created between them. Since the upper yoke element on the retaining element is arranged above the contact bridge, while the lower yoke element is arranged below the contact bridge, the lower yoke element can be pulled upwards, i.e. in the direction of the upper yoke element, by the resulting attractive force between the yoke elements. This effect can reinforce the retaining effect described above. Due to the contact spring, the lower yoke element can exert a force on the contact bridge, so that the contact bridge is thus also additionally pressed upwards and thus in the direction of the at least one fixed contact. The greater the electric current flowing through the contact bridge, the stronger the acting attraction force between the yoke elements. However, since the contact spring strives to push the lower yoke element away from the contact bridge and thus also away from the upper yoke element, and the lower yoke element is movably mounted on the retaining element, the spring force can be greater than the attractive force between the yoke elements if the electrical currents through the contact bridge are sufficiently small. Only when the attractive force between the yoke elements exceeds the spring force of the contact spring can the lower yoke element move in the direction of the upper yoke element and thereby press the contact bridge more strongly against the at least one fixed contact by means of the now more compressed contact spring. In this way, the levitation effect described above can be counteracted to a greater extent, especially in the case of a short-circuit current.

Thus, in a switched-on state of the switching device, as described, an electric current can flow through the contact bridge, generating a magnetic flux that causes an attractive force between the contact bridge and the upper yoke element and, if present, between the lower yoke element and the upper yoke element. In case the contact arrangement comprises the lower yoke element, the contact arrangement and the upper yoke element are configured such that when the electrical current is less than a current threshold, the lower yoke element is spaced a first distance from the upper yoke element and that when the electrical current is greater than the current threshold, the lower yoke element is spaced a second distance from the upper yoke element, the second distance being less than the first distance. The first and second distances can correspond, for example, to the respective size of the air gap, which thus becomes smaller when the current threshold is exceeded. Accordingly, during operation of the switching device, the air gap between the lower yoke element and the upper yoke element is dependent on an electric current flowing through the contact bridge.

Below the current threshold, the air gap and thus the first distance can be more than 1 mm, for example up to 3 mm or even up to 5 mm, and thus considerably larger compared to the prior art described above, in which the air gap continues to be also essentially invariable. After exceeding the current threshold, the air gap and thus the second distance can be smaller than 1 mm and particularly preferably equal to 0 or at least approximately 0. In other words, after the current threshold has been exceeded, it can preferably be possible, given a suitable geometrical design of the contact arrangement and the upper yoke element, for the lower yoke element to be drawn towards the upper yoke element to such an extent that the lower yoke element bears against the upper yoke element or there is at least an air gap of less than 1 mm.

The current threshold can be adjusted by a suitable choice of the spring constants of the contact spring and the geometric design and size of the yoke elements as well as the first distance. In particular, the current threshold can be set so that electrical currents corresponding to normal operation of the switching device are below the current threshold. In this way, it can be achieved that in normal operation as well as, for example, also for small short-circuit currents, the attractive force between the yoke elements is low due to the large air gap with the first spacing, so that no increased contact pressure is generated between the contact bridge and the at least one fixed contact and the contact bridge is held on the at least one fixed contact solely by the contact spring. Only when the current threshold is exceeded by a higher short-circuit current does the lower yoke element move towards the upper yoke element, so that stronger levitation forces can be compensated for by the attractive force of the yoke elements. The air gap is thus designed to be variable as described, depending on the electric current flowing through the contact bridge, which likewise makes the retaining force variable. It can be achieved that the additional retaining force caused by the lower yoke element is “switched on” by the yoke elements only in the event of a short circuit, when the lower yoke element closes the magnetic circuit with the upper yoke element.

The fact that in the switching device described here the upper yoke element is preferably fixed directly to the switching chamber means that it is no longer dependent on the retaining force of the magnetic drive of the switching device and thus on the retaining force of the coil, as is the case in the prior art described above. The upper yoke element of the switching device described here can thus absorb large forces, in particular forces of more than 500 N. In the prior art solutions, on the other hand, the forces caused by yoke elements are typically limited to about 100 N, since these can only be as large as the retaining force of the magnetic drive coil. Consequently, significantly larger short-circuit currents are possible in the switching device described here. While it has been shown that solutions known in the prior art are typically only suitable for short-circuit currents of up to 8 kA during a period of 5 ms, tests with the switching device described here have shown that short-circuit currents of up to 16 kA are possible.

Compared to the complex setups in the prior art, the anti-levitation effect described here can essentially be achieved with only one additional component, namely the upper yoke element. As described above, an increase in the anti-levitation effect can be achieved with the additionally foreseeable lower yoke element and thus with the upper and lower yoke elements, and can furthermore be selectively switched on. Furthermore, irrespective of the presence of the lower yoke element, the arrangement of the upper yoke element on the switching chamber can ensure that the upper yoke element is not moved during switching. This reduces the dynamic mass in favor of a faster shifting process.

Further advantages, advantageous embodiments and further developments are revealed by the embodiments described below in connection with the figures.

### BRIEF DESCRIPTION OF THE DRAWINGS

FIG. 1 shows a schematic illustration of an example of a switching device;

FIGS. 2A to 2F show schematic illustrations of sections and parts of a switching device according to an embodiment;

FIG. 3 shows a schematic illustration of the effect of the upper yoke element on the contact bridge;

FIGS. 4A and 4B show schematic illustrations of parts of a switching device according to further embodiments;

FIGS. 5A to 5D show schematic illustrations of sections and parts of a switching device according to an embodiment; and

FIGS. 6A to 6D show schematic illustrations of sections of a switching device according to further embodiments.

### DETAILED DESCRIPTION OF ILLUSTRATIVE EMBODIMENTS

In the embodiments and figures, identical, similar or identically acting elements are provided in each case with the same reference numerals. The elements illustrated and their size ratios to one another should not be regarded as being to scale, but rather individual elements, such as for example layers, components, devices and regions, may have been made exaggeratedly large to illustrate them better and/or to aid comprehension.

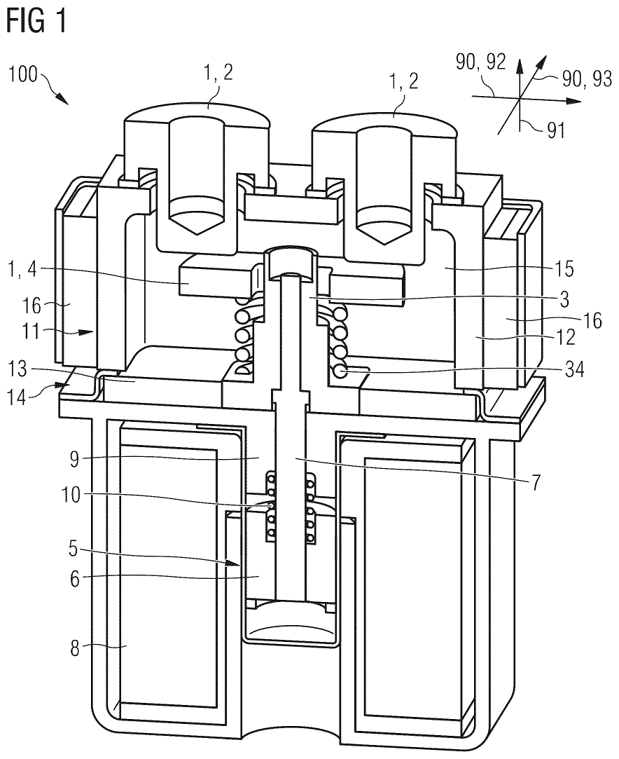

FIG. 1 shows an example of a switching device 100 which can be used, for example, for switching strong electrical currents and/or high electrical voltages and which can be a relay or contactor, in particular a power contactor. FIG. 1 shows a three-dimensional sectional view with a vertical sectional plane. The geometries shown are only exemplary and are not to be understood as limiting and can also be embodied alternatively.

The switching device 100 has contacts 1 in a housing (not shown), which are also referred to below as switching contacts. The housing serves primarily as contact protection for the components arranged inside and has a plastic or is made of plastic, for example PBT or glass fiber-filled PBT. In the example shown, the switching device wo has as contacts 1 two fixed contacts 2 and a movable contact mounted on an insulator 3 in the form of a contact bridge 4. The contact bridge 4 is embodied as a contact plate. The fixed contacts 2 together with the contact bridge 4 form the switching contacts. As an alternative to the number of contacts shown, other numbers of contacts 1, i.e. other numbers of fixed and/or movable contacts, can also be possible. The fixed contacts 2 and/or the contact bridge 4 can, for example, be made with or of Cu, a Cu alloy, one or more refractory metals such as, for example, Wo, Ni and/or Cr, or a mixture of said materials, for example of copper with at least one further metal, for example Wo, Ni and/or Cr.

In FIG. 1, the switching device wo is shown in a switched-off state in which the contact bridge 4 is spaced apart from the fixed contacts 2 so that the contacts 2, 4 are galvanically isolated from each other. The shown configuration of the switching contacts and in particular their geometry are to be understood as purely exemplary and not limiting. Alternatively, the switching contacts can also be embodied differently.

The switching device 100 has a movable armature 5 that substantially performs the switching movement. The armature 5 has a magnetic core 6, for example with or made of a ferromagnetic material. Furthermore, the armature 5 has a shaft 7 which is guided through the magnetic core 6 and is fixedly connected to the magnetic core 6 at one end of the shaft. At the other end of the axis opposite the magnetic core 6, the armature 5 has the contact bridge 4. The shaft 7 can preferably be made with or of stainless steel.

To electrically isolate the contact bridge 4 from the shaft 7, the insulator 3, which can also be referred to as the bridge insulator, is arranged between them. To help compensate for possible height differences and to ensure sufficient mechanical contact between the fixed contacts 2 and the contact bridge 4, a contact spring 34 is arranged below the contact bridge 4, which is supported on the insulator 3 and which exerts a force on the contact bridge 4 in the direction of the fixed contacts 2.

The magnetic core 6 is surrounded by a coil 8. A current flow in the coil 8, which can be switched on from outside by a control circuit, generates a movement of the magnetic core 6 and thus of the entire armature 5 in the axial direction until the contact bridge 4 makes contact with the fixed contacts 2. In the illustration shown, the armature moves upward for this purpose. The armature 5 thus moves from a first position, a rest position, which corresponds to the disconnecting, i.e. non-through-connecting and thus switched-off state, to a second position, which corresponds to the active, i.e. through-connecting and thus switched-on state. In the active state, the contacts 1 are galvanically connected to each other.

For guiding the shaft 7 and thus the armature 5, the switching device 100 has a yoke 9, which can comprise or be pure iron or a low-doped iron alloy and which forms part of the magnetic circuit. The yoke 9 has an opening in which the shaft 7 is guided. When the current flow in the coil 8 is interrupted, the armature 5 is moved back to the first position by one or more springs 10. In the illustration shown, the armature 5 thus moves back down. The switching device 100 is then again in the rest state, in which the contacts 1 are open.

The direction of movement of the armature 5 and thus of the contact bridge 4 is also referred to in the following as the vertical direction 91. The direction of arrangement of the fixed contacts 2, which is perpendicular to the vertical direction 91, is referred to below as the longitudinal direction 92. The direction perpendicular to the vertical direction 91 and perpendicular to the longitudinal direction 92 is hereinafter referred to as the transversal direction 93. Directions 91, 92 and 93, which also apply independently of the described switching motion, are indicated in some figures to facilitate orientation. Directions that are parallel to a plane spanned by the longitudinal direction 92 and the transversal direction 93, and thus perpendicular to the vertical direction 91, are also referred to as lateral directions 90.

For example, when opening the contacts 1, at least one electric arc can be generated which can damage the contact surfaces of the contacts 1. As a result, there can be a risk that the contacts 1 can “stick” to each other due to a welding caused by the arc and can no longer be separated from each other. The switching device 100 then continues to be in the switched-on state, although the current in the coil 8 is switched off and thus the load circuit should be disconnected. In order to prevent such arcs from occurring, or at least to assist in extinguishing arcs that do occur, the contacts 1 can be arranged in a gas atmosphere, so that the switching device 100 can be embodied as a gas-filled relay or gas-filled contactor. In particular, the contacts 1 are arranged within a switching chamber 11, for example formed by a switching chamber wall 12 and a switching chamber base 13, in a gas-tight region 14 formed by a hermetically sealed portion, wherein the switching chamber 11 can be part of the gas-tight region 14. The gas-tight region 14 completely surrounds the armature 5 and the contacts 1, except for parts of the fixed contacts 2 provided for external connection. The gas-tight region 14, and thus also the interior 15 of the switching chamber 11, are filled with a gas. The gas-tight region 14 is essentially formed by parts of the switching chamber 11, the yoke 9 and additional walls. The gas that can be filled into the gas-tight region 14 through a gas filling nozzle as part of the manufacturing of the switching device wo can particularly preferably be hydrogen-containing, for example with 20% or more H₂ in an inert gas or even with 100% H₂, since hydrogen-containing gas can promote the extinguishing of arcs. Furthermore, so-called blowing magnets can be present inside or outside the switching chamber 11, i.e. permanent magnets 16, which can cause a prolongation of the arc gap and thus improve the extinguishing of the arcs.

The switching chamber wall 12 and the switching chamber base 13 can, for example, be made with or from a metal oxide such as Al₂O₃. Furthermore, plastics with a sufficiently high temperature resistance are also suitable, for example a PEEK, a PE and/or a glass fiber-filled PBT. Alternatively or additionally, the switching chamber 11 can also comprise POM, in particular with the structure (CH₂O)ₙ, at least in part. Such a plastic can be characterized by a comparatively low carbon content and a very low tendency to form graphite. Due to the equal proportions of carbon and oxygen, particularly in the case of (CH₂O)ₙ, predominantly gaseous CO and H₂ can be formed during a heat-induced and, in particular, an arc-induced decomposition. The additional hydrogen can enhance arc quenching.

The features of the switching device 100 described above are to be understood as purely exemplary and not limiting. For example, as an alternative to the described embodiment as a gas-filled contactor, the switching device wo can also be embodied without gas filling. In particular, the above description of the example of FIG. 1 serves to clarify the operation of switching devices.

The following are embodiments of a switching device wo that, compared to the switching device of FIG. 1, includes a contact arrangement 200 and an upper yoke element 50 or a lower yoke element 40 and an upper yoke element 50 that form an anti-levitation mechanism.

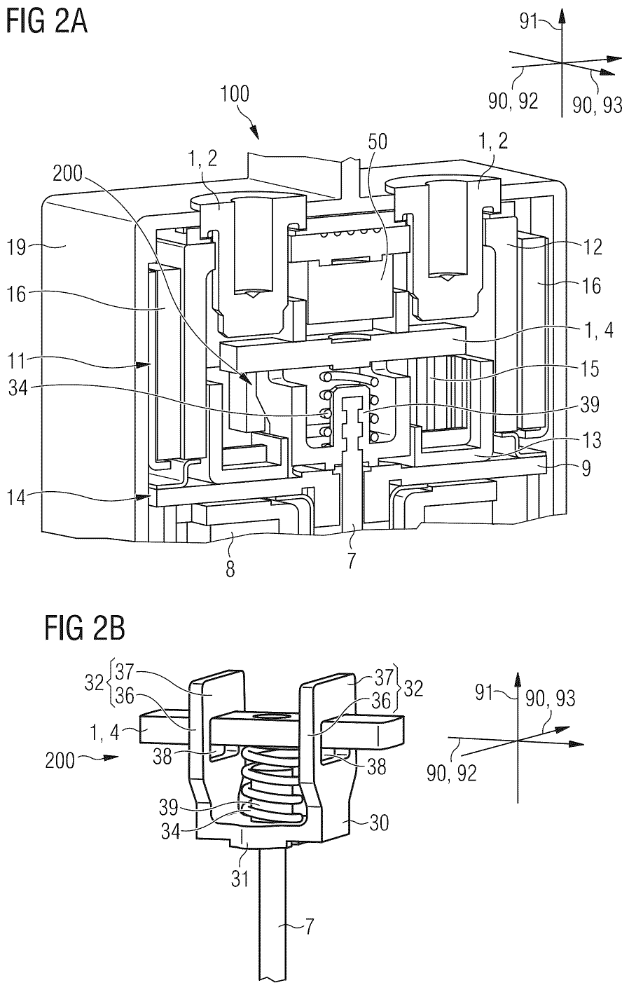

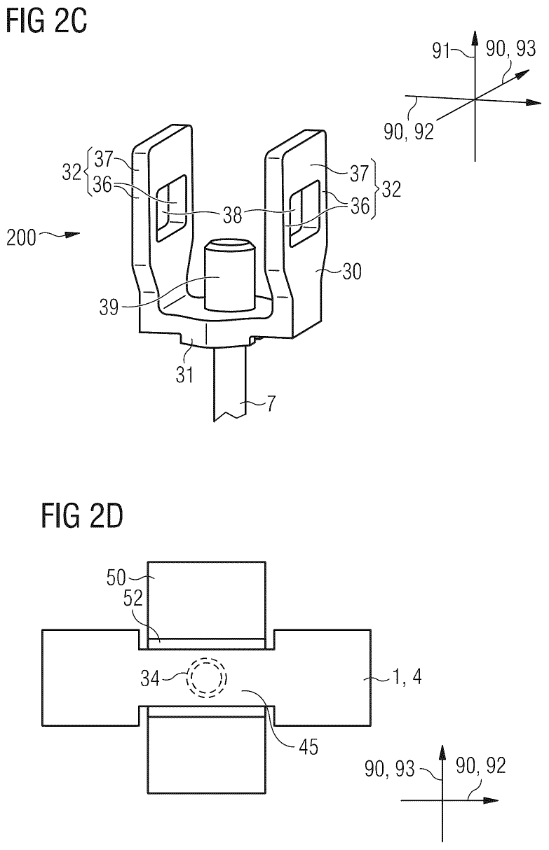

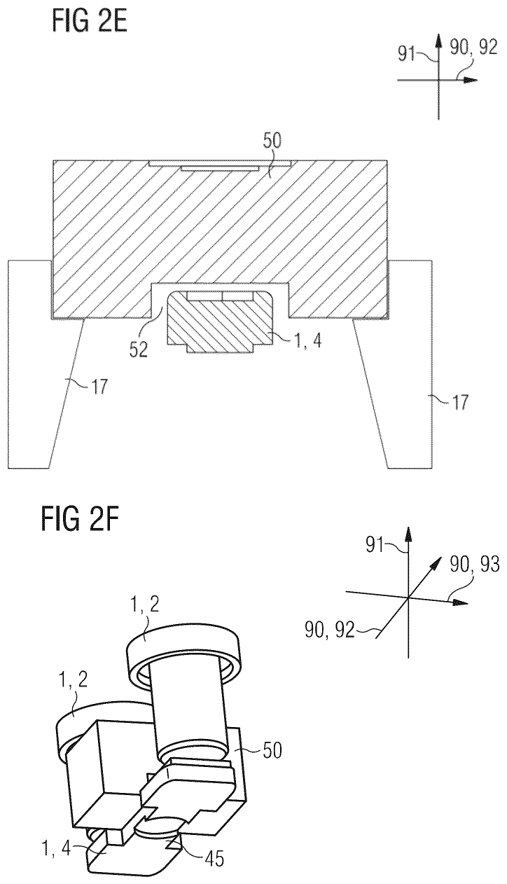

FIGS. 2A to 2F show different sections and parts of the switching device wo according to one embodiment. FIG. 2A shows a three-dimensional sectional view of a part of the switching device wo with the contact arrangement 200, while FIGS. 2B to 2F show different views of parts of the switching device 100 and in particular of the contact arrangement 200. The following description of the switching device wo refers equally to all FIGS. 2A to 2F. Unless otherwise stated, the elements shown in FIGS. 2A to 2F correspond to the elements explained in connection with FIG. 1.

In FIG. 2A, in comparison to the view in FIG. 1, the housing 19 of the switching device 100 is also shown. The contact arrangement 200 is arranged in the switching chamber 11, has the contact bridge 4 as well as a retaining element 30 and is attached to the shaft 7. As a result, the contact arrangement 200 can be moved to perform the switching movements of the switching device 100 by the magnetic drive described above.

Further, the switching device 100 includes an upper yoke element 50. The upper yoke element 50 can comprise or be made of iron. In particular, the upper yoke element 50 can comprise or be made of pure iron. The contact bridge 4 is arranged below the upper yoke element 50 by the retaining element 30.

The upper yoke element 50 is no part of the contact arrangement 200, but is arranged in the switching chamber 11 independently of the contact arrangement 200 and thus independently of the lower yoke element 40. In particular, the upper yoke element 50 is arranged and fixed relative to the fixed contacts 2 therebetween. As can be seen in FIG. 2A, the upper yoke element 50, as well as the fixed contacts 2, is preferably attached to the switching chamber 11, in particular the switching chamber wall 12, which can for example comprise a ceramic material to provide sufficient stability. For example, the upper yoke element 50 the fixed contacts 2 can each be attached to the switching chamber by soldering. For this purpose, the upper yoke element 50 can comprise a solder flange. In particular, the upper yoke element 50 can be attached to an inner side of the switching chamber 11 by soldering. Alternatively, the upper yoke element 50 can also be attached to the switching chamber 11 by bonding, riveting, screwing or press-fit stem. For example, the upper yoke element 50 can be held to the inside of the switching chamber 11 by means of a fastening part 17, such as one made of a plastic material, which is indicated as optional component in FIG. 2E.

The retaining element 30 is attached to the shaft 7. In the embodiment shown, the retaining element 30 comprises an electrically insulating plastic, in particular a plastic described above in the general part, wherein a part of the shaft 7 is molded with the material of the retaining element 30, as can be seen in FIG. 2A. For locking the retaining element 30 and thus the contact arrangement 200, the shaft 7 has an anchoring element in the form of grooves which extend all the way around the shaft 7 and in which the material of the retaining element 30 can engage. Alternatively, another fastening method is also possible, for example by means of rivets or screws.

The retaining element 30 has a base plate 31 attached to the shaft 7. On the base plate 31, the retaining element 30 has clamp elements 32 for movably supporting the contact bridge 4, as indicated in FIGS. 2B and 2C. The retaining element 30 can particularly preferably be formed in one piece and comprise a material described above in the general part. The contact bridge 4 is shiftably mounted on the retaining element 30 by the clamp elements 32. In particular, the contact bridge 4 is shiftably mounted on the retaining element along a direction of movement that is parallel to the shaft 7. For guiding the contact bridge 4, the retaining element 30 has guide elements 36 and stops 37, which form the clamp elements 32. The guide elements 36 are embodied as guide rails and allow the contact bridge 4 to be moved along the desired displacement direction, while the mobility of the contact bridge 4 in other directions is limited by the guide elements 36. To limit the shiftability of the contact bridge 4 in particular along the direction of movement along the shaft 7, the retaining element 30 has stops 37 which are arranged on a side of the guide elements 36 opposite the base plate 31. In particular, each two guide elements and one stop 37 form a clamp element 32, each of which forms an opening 38 with the base plate 31. As shown in FIG. 2B, each of the clamp elements 32 embraces the contact bridge 4. In other words, the contact bridge 4 can protrude through the openings 38 and can thereby be guided within the openings 38 of the clamp elements 32.

The retaining element 30 can further be configured such that the stops 37 each protrude into a space between a fixed contact 2 and the upper yoke element 50 in a switched-on state of the switching device 100, as can be seen in FIG. 2A. In this way, for example, at least partial electrical isolation of the upper yoke element 50 from the fixed contacts 2 can be achieved.

The contact arrangement 200 further comprises a contact spring 34 arranged on the lower side of the contact bridge 4 facing the base plate 31. In other words, the contact spring 34 is arranged between the contact bridge 4 and the base plate 31. The retaining element 30, and in particular the base plate 31 of the retaining element 30, has a spring retainer 39 which counteracts a displacement of the contact spring 34 on the retaining element 30. As shown, the spring retainer 39 can, for example, comprise or be formed from a pin surrounded by a part of the contact spring 34.

The contact spring 34 is embodied as a compression spring. As described above, the contact spring 34 can be used in conjunction with an overtravel to increase a contact pressure of the contact bridge 4 against the fixed contacts 2. By the contact spring 34 being arranged between the contact bridge 4 and the base plate 31, the contact spring 34 strives to press the contact bridge 4 and the base plate 31 apart, thereby pressing the contact bridge 4 towards the fixed contacts 2.

The upper yoke element 50 has a recess 52 on the lower side facing the contact bridge 4. As can be seen in FIGS. 2A, 2E and 2F, the recess 52 can in particular be formed as a channel-like or groove-like recess. The contact bridge 4 can extend at least partially into the recess 52 when the switching device 100 is in a switched-on state. Furthermore, as can be seen, for example, in FIG. 2D in a view of the lower side of the contact bridge 4 and of the lower side of the upper yoke element 50, the contact bridge 4 can have a constriction 45, that is, a region, for example, in the form of a web, with a reduced width in comparison with the contact regions of the contact bridge 4, the constriction 45 being arranged at least partially in the recess 52 of the upper yoke element 50 in a switched-on state of the switching device boo. In particular, the recess 52 has a width that is greater than a width of the contact bridge 4 at least in the region of the constriction 45. Further, the recess 52 can have a depth that is less than or equal to or substantially equal to a thickness of the contact bridge 4. The contact bridge 4 can enter the recess 52 during the transition from a switched-off state to a switched-on state of the switching device 100 due to the switching movement of the contact arrangement 200. Thus, in a switched-on state of the switching device 100, the upper yoke element 50 can at least partially embrace the contact bridge 4 in lateral direction 90, in particular in transversal direction 93. FIG. 2D further indicates the position of the contact spring 34.

Particularly preferably, the contact bridge 4 can have a thickness that is greater than the depth of the recess 52, as can be seen in particular in FIG. 2E. The upper yoke element 50 can thus only partially embrace the contact bridge 4 in a switched-on state. The contact bridge can thus partially protrude from the recess 52 in the switched-on state of the switching device 100.

Furthermore, the contact bridge 4 can particularly preferably be spaced from the upper yoke element 50 in the switched-on state. As can also be seen in FIG. 2E, this makes it possible for the contact bridge to have no mechanical contact with the upper yoke element 50 in the switched-on state. Accordingly, an air gap can remain between the upper yoke element 50 and the contact bridge 4 even in the switched-on state. By providing such a gap, manufacturing tolerances can be taken into account, for example. In addition, it can be achieved that a possible burn-off, i.e. an erosion and uncontrolled deposition of material of the contacts 1, as can occur, for example, during the formation of switching arcs, cannot lead to any undesired consequences.

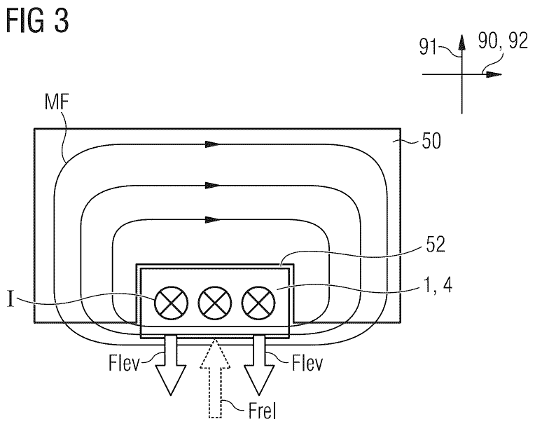

Together with the contact bridge 4, the upper yoke element 50 forms an anti-levitation mechanism, the operation of which is indicated in connection with FIG. 3 by means of a section of the switching device 100 in a sectional view with a sectional plane along the vertical direction 91 and transversal direction 92. The switching device wo is shown here in a switched-on state in which an electric current I flows through the contact bridge 4. In particular, in the case of a short-circuit current, as described above in the general part, a levitation force Flev can occur which pushes the contact bridge 4 away from the fixed contacts. Without the effect described below, the levitation force is counteracted only by the spring force of the contact spring.

As indicated in FIG. 3, in the switching device described here, a magnetic field with a magnetic flux MF is induced in the upper yoke element 50 in the switched-on state of the switching device when a current flows through the contact bridge 4. In this case, especially in the case of a large current such as a short-circuit current through the contact bridge 4, the magnetic field lines can be concentrated on the upper surface of the upper yoke element 50. A large thickness of the upper yoke element 50 above the contact bridge 4 can be advantageous in this regard. In particular, the upper yoke element 50 can have a greater thickness than the contact bridge 4, especially preferably in the vertical direction 91 above the contact bridge 4.

Since the field strives for the shortest path to minimize energy, the field on the lower side facing the contact bridge 4 and through the contact bridge 4 is strongly compressed and generates a reluctance force Frel on the contact bridge 4, which counteracts the levitation force and which can accordingly also be referred to as an anti-levitation force. Thus, a retaining effect can be achieved by a flux of the magnetic field from the upper yoke element 50 through the contact bridge 4.

In connection with the following figures, modifications and further developments of the switching device are explained.

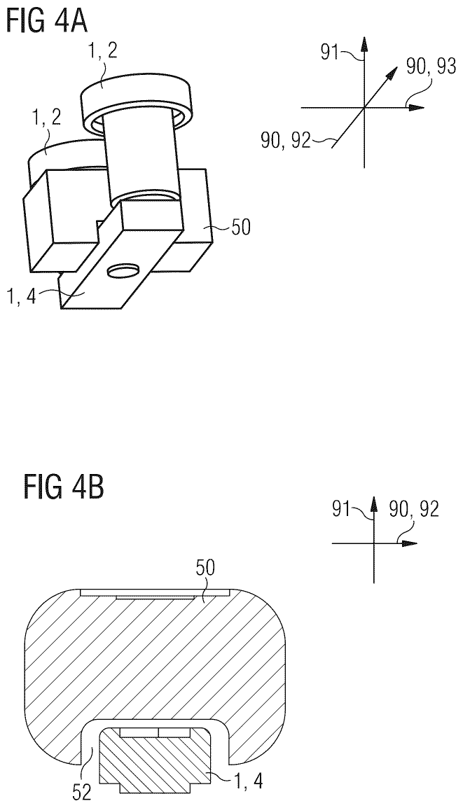

As indicated in FIG. 4A, the contact bridge 4 can also be formed without a constriction and thus have, for example, a simple cuboid shape. Furthermore, it can also be possible, as indicated in FIG. 4B, that one or more or all edges of the upper yoke element 5o and/or the contact bridge 4 are rounded or chamfered.

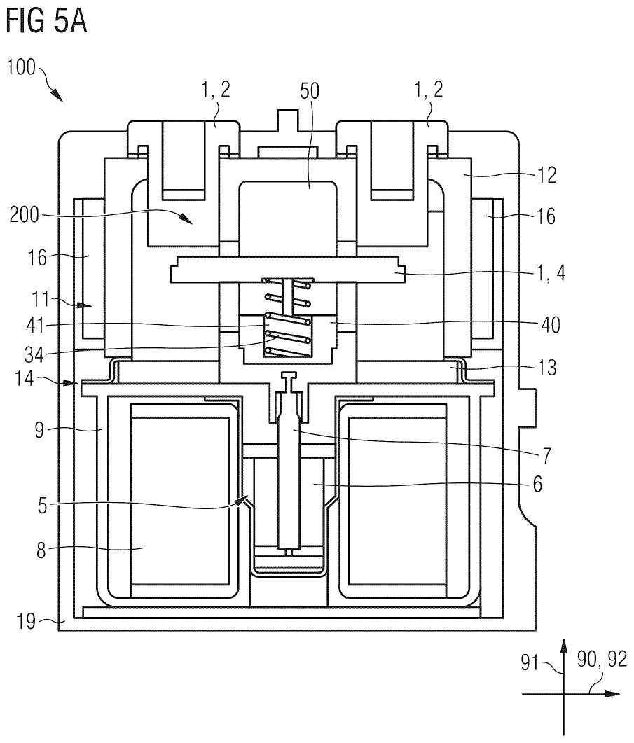

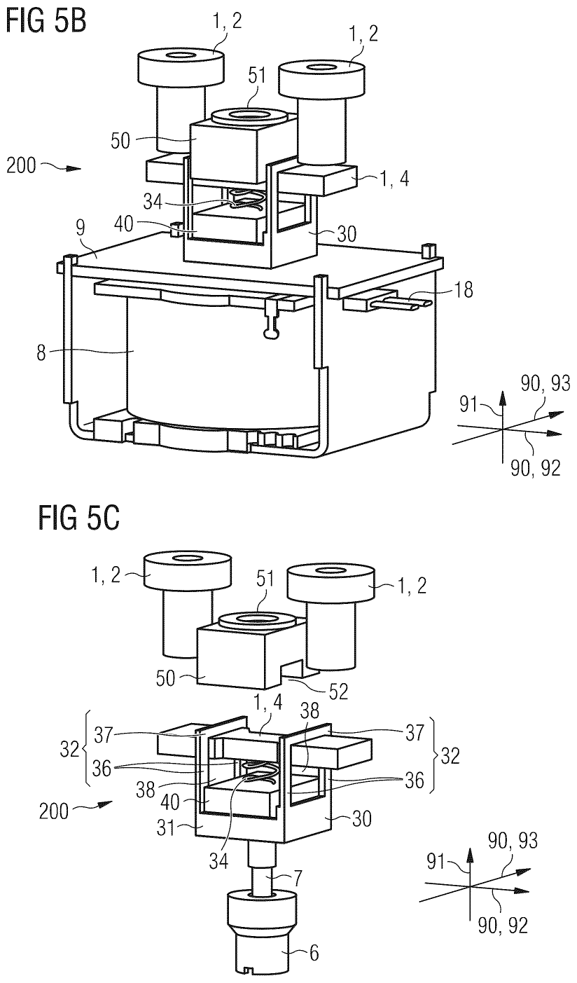

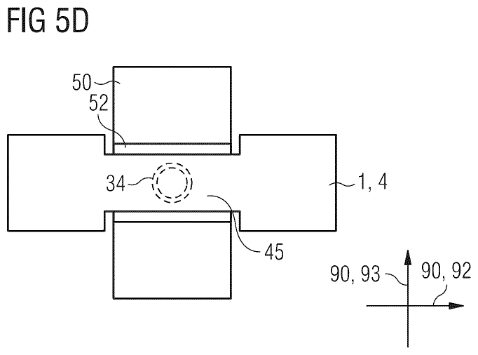

In connection with the figures described below, a further embodiment of the switching device 100 is explained. FIGS. 5A to 5D show various sections and parts of the switching device 100 according to the further embodiment. FIG. 5A shows a sectional view of the switching device 100 with the contact arrangement 200, while FIGS. 5B to 5D show different views of parts of the switching device 100 and in particular of the contact arrangement 200. The following description of the switching device 100 refers equally to all FIGS. 5A to 5D.

In FIG. 5A, in comparison to the view in FIG. 1, the housing 19 of the switching device 100 is additionally shown, while in comparison to FIG. 1, the return spring 10 for returning the armature 5 to the switched-off state is not shown for the sake of clarity. FIG. 5B further shows coil connections 18 for driving the coil 8. Unless otherwise stated, the elements shown in FIGS. 5A to 5D correspond to the elements explained in connection with FIG. 1 and with FIGS. 2A to 3.

The contact arrangement 200 is arranged in the switching chamber 11, has the contact bridge 4, a retaining element 30 and a lower yoke element 40, and is attached to the shaft 7. This allows the contact arrangement 200 to be moved to perform the switching movements of the switching device 100 by the magnetic drive described above.

Furthermore, as in the embodiment of FIGS. 2A to 2F, the switching device wo includes an upper yoke element 50. The lower yoke element 40 and the upper yoke element 50 can each comprise or be made of iron. In particular, the yoke elements 40, 50 can each comprise or be made of pure iron. The contact bridge 4 is arranged between the lower yoke element 40 and the upper yoke element 50.

As described in connection with FIGS. 2A to 2F, the upper yoke element 50 is not a part of the contact arrangement 200, but is arranged and secured within the switching chamber 11 independently of the contact arrangement 200 and thus independently of the lower yoke element 40, as explained in connection with FIGS. 2A through 2F.

The retaining element 30 is attached to the shaft 7. In the embodiment shown, the retaining element 30 comprises an electrically insulating plastic, in particular a plastic described above in the general part, wherein a part of the shaft 7 is molded with the material of the retaining element 30. The shaft 7 has an anchoring element in the form of a groove for locking the retaining element 30 and thus the contact arrangement 200, as can be seen in FIG. 5A, which groove extends all the way around the shaft 7 and in which the material of the retaining element 30 can engage. Alternatively, another fastening method is also possible, for example by means of rivets or screws.

The retaining element 30 has a base plate 31 that is attached to the shaft 7. On the base plate 31, the retaining element 30 has clamp elements 32 for movably supporting the contact bridge 4 and the lower yoke element 40. The retaining element 30 can particularly preferably be formed in one piece and comprise a material described above in the general part.

The contact bridge 4 and the lower yoke element 40 are each shiftably mounted on the retaining element 30. Accordingly, the position of the lower yoke element 40 relative to the upper yoke element 50 can vary depending on the condition of the switching device 100. In one aspect, the relative position of the lower yoke element 40 to the upper yoke element 50 can change as a result of a displacement of the lower yoke element 40 on the retaining element 30 and thus in the contact arrangement 200. Thus, as described in more detail below, an air gap between the lower yoke element 40 and the upper yoke element 50 can be changeable, particularly in a switched-on state of the switching device 100. Further, the position of the lower yoke element 40 relative to the upper yoke element 50 can change as a result of movement of the contact arrangement 200 in the switching chamber it Particularly preferably, the lower yoke element 40 is mounted on the retaining element 30 such that the lower yoke element 40 is displaceable along a direction of movement that is parallel to the shaft 7 and thus extends along the vertical direction 91. Furthermore, the contact bridge 4 is also shiftably mounted on the retaining element along a direction of movement that is parallel to the shaft 7. Thus, the contact bridge 7 and the lower yoke element 40 as well as the contact bridge 7 and the upper yoke element 50 can also be shiftable relative to each other.

The lower yoke element 40 can rest on the base plate 31 at least in the switched-off state of the switching device 100 indicated in FIGS. 5A to 5C. For secure positioning, the lower yoke element 40 can have, for example, edge-side grooves on the side facing the base plate 31, in which projections of the base plate 30 can engage.

For guiding the contact bridge 4 and the lower yoke element 40, the retaining element 30 has guide elements 36 and stops 37. The guide elements 36 are embodied as guide rails and allow the contact bridge 4 and the lower yoke element 40 to be moved along the desired displacement direction, while the movability of the contact bridge 4 and the lower yoke element 40 in other directions is limited by the guide elements 36. To limit the shiftability of the contact bridge 4 and the lower yoke element 40, in particular along the direction of movement along the shaft 7, the retaining element 30 has stops 37 which are arranged on a side of the guide elements 36 opposite the base plate 31. In particular, each two guide elements and one stop 37 form a clamp element 32, each of which forms an opening 38 with the base plate 31. As shown in FIG. 5C, each of the clamp elements 32 embraces the contact bridge 4. In other words, the contact bridge 4 can extend through the openings 38 and can thereby be guided within the openings 38 of the clamp elements 32. In the embodiment shown, the lower yoke element 40 is guided between the clamp elements 32. Alternatively or additionally, however, the lower yoke element 40 can be configured to protrude through the openings 38 and be guided within the openings 38 and thus be embraced by the clamp elements 32.

The retaining element 30 can further be configured such that the stops 37 each protrude into a space between a fixed contact 2 and the upper yoke element 50 in a switched-on state of the switching device 100, as can be seen in FIG. 5B. In this way, for example, at least partial electrical isolation of the upper yoke element 50 from the fixed contacts 2 can be achieved.

The contact arrangement 200 further comprises a contact spring 34 arranged on the lower side of the contact bridge 4 facing the lower yoke element 40. In other words, compared to the embodiment example of FIGS. 2A to 2F, the contact spring 34 is arranged between the contact bridge 4 and the lower yoke element 40. The contact spring 34 is configured as a compression spring. As described above, a contact pressure of the contact bridge 4 against the fixed contacts 2 can be increased by the contact spring 34 in conjunction with an overtravel. Due to the fact that the contact spring 34 is arranged between the contact bridge 4 and the lower yoke element 40, the contact spring 40 strives to press the contact bridge 4 and the lower yoke element 40 apart. The contact spring 34 thus generates a spring force that counteracts an approach of the lower yoke element 40 to the contact bridge 4. As shown, the contact spring 34 can in particular be supported directly on the lower side of the contact bridge 4 and/or directly on the lower yoke element 40. The lower yoke element 40 has a recess 41 into which the contact spring 34 projects and through which the position of the contact spring 34 can be fixed.

The upper yoke element 50 has a recess 52 on the lower side facing the contact bridge 4. As shown, the recess 52 can be formed in particular as a channel-like or groove-like recess. The contact bridge 4 can protrude at least partially into the recess 52 when the switching device 100 is in a switched-on state. Furthermore, as can be seen in FIG. 5D in a view of the lower side of the contact bridge 4 and of the lower side of the upper yoke element 50, as already explained in connection with the embodiment example of FIGS. 2A to 2F, the contact bridge 4 can have a constriction 45, i.e., a region, for example, in the form of a web, with a reduced width compared to the contact regions of the contact bridge 4, the constriction 45 being arranged at least partially in the recess 52 of the upper yoke element 50 in a switched-on state of the switching device 100. In particular, the geometrical configuration of the contact bridge 4 and the upper yoke element 50 can be as described in connection with FIGS. 2A to 4B.

Alternatively or in addition to the embodiment shown, for example, the lower yoke element 40, which is plate-shaped in the embodiment example shown, can also have a recess corresponding to the recess 52, while the upper yoke element 50 can have a flat lower side. Furthermore, it can also be possible for both yoke elements 40, 50 to each have a recess through which each of the yoke elements 40, 50 can partially engage around the contact bridge 4 from below or from above when in a corresponding position relative to the contact bridge 4.

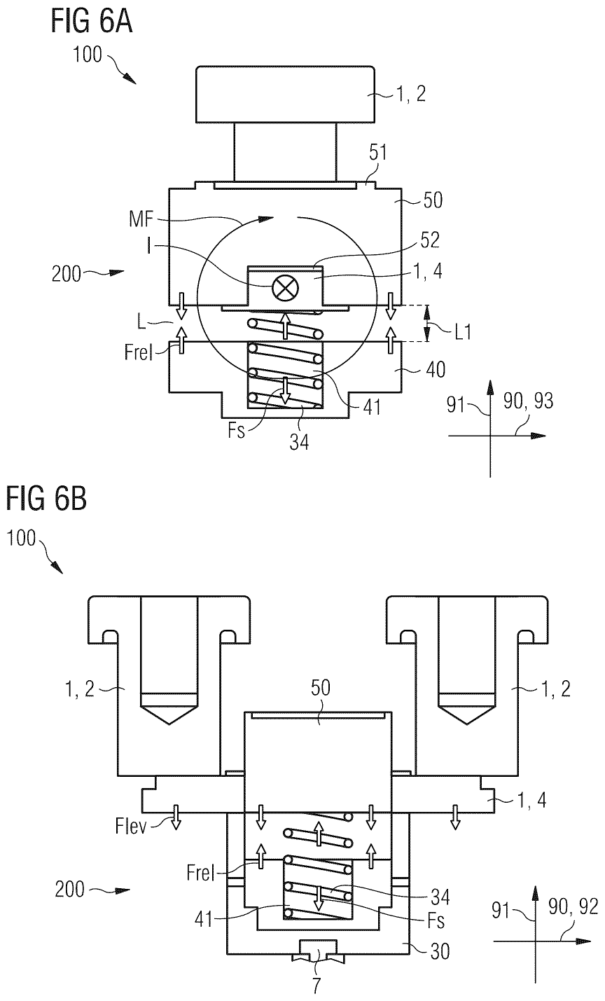

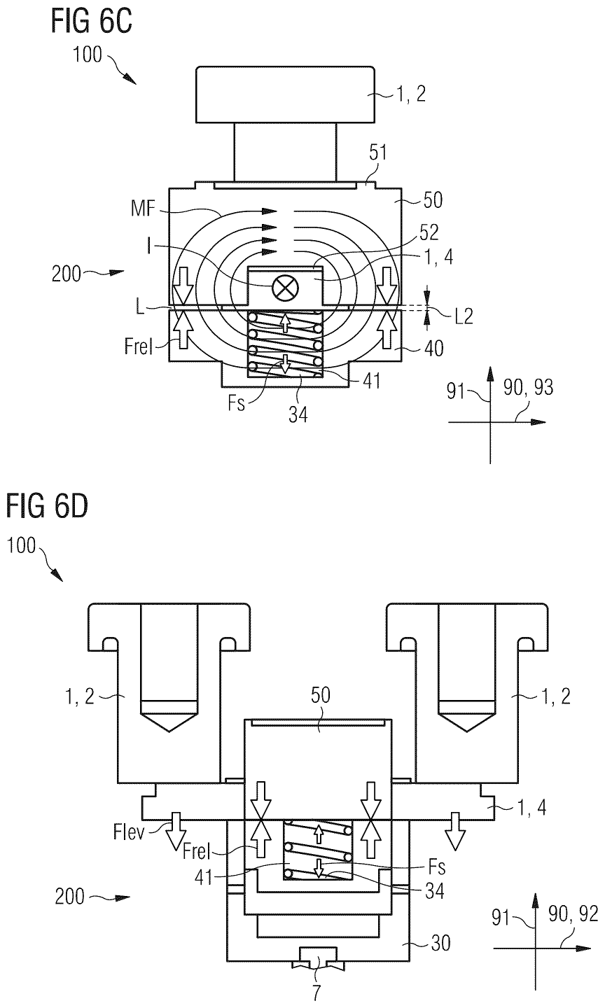

In addition to the effect described in connection with FIG. 3, the contact arrangement 200 and in particular the lower yoke element 40 and the upper yoke element 50 form a further anti-levitation mechanism, the operation of which is explained in connection with FIGS. 6A to 6D on the basis of sections of the switching device 100 in sectional views with sectional planes along the vertical direction 91 and longitudinal direction 93 (FIGS. 6A, 6C) along the vertical direction 91 and transversal direction 92 (FIGS. 6B, 6D). Here, the switching device 100 is shown in a switched-on state in which an electric current I flows through the contact bridge 4, as indicated in FIGS. 6A and 6C.

In the switched-off state of the switching device 100, the moving parts of the switching device 100 rest in the lower rest position, as shown, for example, before in FIG. 5A. The electrical contact between the fixed contacts 2 and the contact bridge 4 is separated in this state. The contact spring 34 biases the contact bridge 4 and the lower yoke element 40 and holds them in position in the cage of the retaining element 30 formed by the base plate 31 and the clamp elements 32. When the switching device 100 is switched on, a control current flows through the coil 8 of the magnetic drive, causing the magnetic core 6 to move upwards. This also causes the contact arrangement 200 with the contact bridge 4, the retaining element 30, the contact spring 34 and the lower yoke element 40 to move upwards by means of the shaft 7, so that the contact bridge 4 is pressed against the fixed contacts 2. The magnetic core 6, the shaft 7, the retaining element 30, the contact spring 34 and the lower yoke element 40 then continue to move upward until the magnetic core abuts against the yoke of the magnetic drive. This further compresses the contact spring 34 and ensures sufficient contact force between the contacts 1 to carry the nominal current continuously. This condition is the normal state of the switching device 100 when energized and is shown in FIGS. 6A and 6B.

The electric current I flowing through the contact bridge 4 induces a magnetic flux MF in the yoke elements 40, 50. The magnetization causes a reluctance force Frel, i.e., an attractive force, between the yoke elements 40, 50, which is directed against the spring force Fs of the contact spring 34. The acting reluctance force Frel, i.e., the attractive force, is stronger the greater the electric current I flowing through the contact bridge 4. However, since the contact spring 34 strives to push the lower yoke element 40 away from the contact bridge 4 and thus also away from the upper yoke element 50, the spring force Fs can be greater than the reluctance force Frel between the yoke elements 40, 50 if the electric currents I are sufficiently small. In this case, which represents normal operation, the moving parts remain in the position shown in FIGS. 6A and 6B.

Between the yoke elements 40, 50 there is an air gap L corresponding to a first distance L1 between the yoke elements 40, 50. The first distance L1 can especially preferably be more than 1 mm and in particular several millimeters, for example 3 mm or even 5 mm.

By a suitable choice of the spring constants of the contact spring 34, the geometric design and size of the yoke elements 40, 50 as well as the first distance L1, a current threshold for the electric current I can be set up to which the state shown in FIGS. 6A and 6B is maintained and the air gap L remains open in the manner shown. The current threshold is preferably above the nominal current and can particularly preferably be even above smaller short-circuit currents. For example, the current threshold can be several kiloamperes, about 5 kA. In the low short-circuit current range below the current threshold, the levitation force Flev that pushes the contact bridge 4 away from the fixed contacts 2 is low, so that the contact spring 34 alone can provide the force to hold the contact bridge 4 to the fixed contacts 2.

If the electric current I through the contact bridge 4 finally exceeds the current threshold, i.e. if there is a condition in which an increased short-circuit current flows through the contacts 1, the reluctance force Frel also increases proportionally with the electric current I and exceeds the spring force Fs. As a result, the lower yoke element 40 moves upward, i.e., toward the upper yoke element 50. This reduces the size of the air gap L, which in turn additionally increases the magnetic flux MF. The reluctance force Frel thus grows exponentially over the spring force Fs. The contact spring 34 is further compressed, preferably until the lower yoke element 40 rests on the lower side of the contact bridge 4 or the lower side of the upper yoke element 50. The air gap L corresponds, as shown in FIGS. 6C and 6D, to a smaller second distance L2 between the yoke elements 40, 50, which in this case can be minimal and even equal to 0 or approximately equal to 0. The contact force is now at a maximum and in particular so large that the reluctance force Frel continues to exceed the levitation force Flev and the contact bridge 4 can continue to be pressed against the fixed contacts 2. Only above a maximum short-circuit current, which can be in the range of 16 kA or more, for example, are the yoke elements 40, 50 saturated by the magnetic flux MF and the levitation force Flev can exceed the reluctance force Frel, which would cause the contact bridge 4 to lift off from the fixed contacts 2.

The air gap L is thus variable as described depending on the electric current I flowing through the contact bridge 4, whereby the retaining force is also variable. It can be achieved that the additional retaining force by the yoke elements 40, 50 only “switches on” in the case of a short circuit above the current threshold, whereby the switching device 100 can carry larger short circuit currents compared to known solutions.

The features and embodiments described in connection with the figures can be combined with each other according to further embodiments, even if not all combinations are explicitly described. Furthermore, the embodiments described in connection with the figures can alternatively or additionally have further features according to the description in the general part.

The invention is not limited by the description based on the embodiments to these embodiments. Rather, the invention includes each new feature and each combination of features, which includes in particular each combination of features in the patent claims, even if this feature or this combination itself is not explicitly explained in the patent claims or embodiments.

What is claimed is:

1. A switching device comprising:
at least one fixed contact, a contact bridge and a upper yoke element in a switching chamber,
wherein the upper yoke element is attached to the switching chamber,
wherein the upper yoke element has a recess on a lower side facing the contact bridge, and
wherein the contact bridge projects at least partially into the recess in an switched-on state of the switching device.

2. The switching device according to claim 1, wherein the upper yoke element is arranged laterally adjacent the at least one fixed contact.

3. The switching device according to claim 1, wherein the switching device comprises two fixed contacts and the upper yoke element is arranged between the two fixed contacts.

4. The switching device according to claim 3, wherein the contact bridge comprises a constriction, which is arranged at least partially in the recess of the upper yoke element in the switched-on state of the switching device.

5. The switching device according to claim 1, wherein the contact bridge partially protrudes from the recess in the switched-on state.

6. The switching device according to claim 1, wherein the contact bridge has a thickness greater than a depth of the recess.

7. The switching device according to claim 1, wherein the contact bridge is spaced from the upper yoke element in the switched-on state.

8. The switching device according to claim 1, wherein the upper yoke element has a greater thickness than the contact bridge above the contact bridge.

9. The switching device according to claim 1, wherein the upper yoke element is attached to the switching chamber by soldering, riveting, screwing, gluing or press-fit stem.

10. The switching device according to claim 1, further comprising:
a contact arrangement movable by a shaft,
wherein the contact arrangement comprises a retaining member and the contact bridge,
wherein the retaining member is attached to the shaft, and
wherein the contact bridge is shiftably mounted on the retaining member.

11. The switching device according to claim 10, wherein the retaining member comprises at least one guide element configured to guide the contact bridge.

12. The switching device according to claim 11, wherein the retaining member comprises at least one clip member, which comprises the at least one guide element and the at least one stop and which at least partially embraces the contact bridge.

13. The switching device according to claim 10, wherein the retaining member comprises at least one stop configured to limit the shiftability of the contact bridge.

14. The switching device according to claim 13, wherein the at least one stop projects into a space between the at least one fixed contact and the upper yoke element in the switched-on state of the switching device.

15. The switching device according to claim 10, wherein the contact arrangement comprises a contact spring, which is arranged on a lower side of the contact bridge facing away from the upper yoke element and which presses the contact bridge in a direction of the at least one fixed contact.

16. The switching device according to claim 15, wherein the contact spring is supported directly on the lower side of the contact bridge and/or directly on the retaining member.

17. The switching device according to claim 15,
wherein the retaining member includes a spring retainer configured to oppose displacement of the contact spring on the retaining member, and
wherein the spring retainer includes a pin surrounded by a part of the contact spring.

18. The switching device according to claim 10,
wherein the contact arrangement further comprises a lower yoke element shiftably mounted to the support member,
wherein an air gap between the lower yoke element and the upper yoke element depends on an electric current flowing through the contact bridge during operation of the switching device, and
wherein the contact bridge is arranged between the lower yoke element and the upper yoke element.

19. The switching device according to claim 18,
wherein a contact spring is arranged between the contact bridge and the lower yoke element, and
wherein the contact spring is configured to press the contact bridge and the lower yoke element apart.

20. A switching device comprising:
at least one fixed contact, a contact bridge and a upper yoke element in a switching chamber,
wherein the upper yoke element is attached to a switching chamber wall of the switching chamber,
wherein the switching chamber wall comprises a ceramic material, and
wherein the upper yoke element is held to an inside of the switching chamber by a fastening part made of a plastic material.
